(19) United States
(12) Patent Application Publication
(10) Pub. No.: US 2015/0029161 A1
(43) Pub. Date: Jan. 29, 2015

(54) METHODS AND APPARATUS FOR IMPLEMENTING DUAL TIP FUNCTIONALITY IN A STYLUS DEVICE

(71) Applicant: FiftyThree, Inc., New York, NY (US)

(72) Inventors: James Koo, Renton, WA (US); John K. Ikeda, Seattle, WA (US); Jonathan R. Harris, Redmond, WA (US); Georg Petschnigg, New York, NY (US); Yao-Kuo Wang, New Taipei City (TW); Chun Chou Yeh, Taipei City (TW); Chien Lung Lu, New Taipei City (TW); Chien I. Lee, Taoyuan City (TW); Hsing Ming Lee, New Taipei City (TW)

(73) Assignee: FiftyThree, Inc., New York, NY (US)

(21) Appl. No.: 14/340,264

(22) Filed: Jul. 24, 2014

Related U.S. Application Data
(60) Provisional application No. 61/857,809, filed on Jul. 24, 2013.
(60) Provisional application No. 61/905,651, filed on Nov. 18, 2013.

(51) Int. Cl. G06F 3/0354

(52) U.S. Cl. CPC G06F 3/03545
USPC 345/179

(57) ABSTRACT

In some embodiments, a stylus device includes two switch mechanisms, one disposed at the stylus tip portion and the other disposed at the stylus end portion. The stylus device also includes a wireless transceiver that allows the stylus device to communicate back to an electronic host device (e.g., an electronic tablet) in response to a user contacting the surface of a host device with the stylus tip portion or the stylus end portion. This enables, for example, a wide range of dual stylus device functions for electronic tablet applications. For example, the stylus device can be used to write and/or draw with the stylus tip portion and then can be flipped to the stylus end portion to erase as a user would generally do with a conventional pencil on paper. In another example, the stylus device can include a marker color tip on the stylus tip portion and a color blender on the stylus end portion.

### CROSS-REFERENCE TO RELATED APPLICATIONS

This application claims priority under 35 U.S.C. §119(e) to Provisional U.S. Patent Application No. 61/857,809, filed Jul. 24, 2013, and to Provisional U.S. Patent Application No. 61/905,651, filed Nov. 18, 2013, each entitled “Method and Apparatus for Implementing Dual Tip Functionality in a Stylus Device,” each of which is incorporated herein by reference in its entirety.

This application is related to Provisional U.S. Patent Application No. 61/857,810, filed Jul. 24, 2013 and co-pending Non-Provisional U.S. patent application having Attorney Docket No. FIFT-009/01US 317784-2030, filed on Jul. 24, 2014, each entitled “Methods and Apparatus for Providing Universal Stylus Device with Functionalities,” and each of which is incorporated herein by reference in its entirety.

This application is related to Provisional U.S. Patent Application No. 61/857,812, filed Jul. 24, 2013 and co-pending Non-Provisional U.S. patent application having Attorney Docket No. FIFT-012/01US 317784-2032, filed on Jul. 24, 2014, each entitled “Stylus Having a Deformable Tip and Methods of Using the Same,” and each of which is incorporated herein by reference in its entirety.

This application is related to Provisional U.S. Patent Application No. 61/857,817, filed Jul. 24, 2013 and co-pending Non-Provisional U.S. patent application having Attorney Docket No. FIFT-013/01US 317784-2034, filed on Jul. 24, 2014, each entitled “Stylus Having a Deformable Tip and Methods of Using the Same,” and each of which is incorporated herein by reference in its entirety.

### BACKGROUND

Some embodiments described herein relate generally to methods and apparatus for implementing dual tip functionality on electronic pens or stylus devices for electronic host devices such as electronic tablets. More specifically, the embodiments described herein relate to a stylus device having two tip portions.

Known computing devices, such as desktop computers, laptop computers, and tablet computers support a wide variety of inputs, including touch-based inputs. A number of input technologies, such as resistive touch screens, capacitive touch screens, optical tracking, etc., support such touch-based inputs. Some such technologies allow a user to interact with the compute device by making a gesture, drawing a shape, writing letters, etc. using his or her finger and/or a stylus device. A stylus device can be analogous to a pen or pencil and can allow the user to exercise greater control over the input as compared to using his or her finger.

Known touch-based input systems, however, are typically operable only to detect contact. Thus, known touch-based input systems are typically unable to distinguish between different styluses and/or between the two end portions of the stylus device. As a result, a stylus device typically does not have dual functionality such as, for example, a first end portion for drawing and/or writing and a second end portion for erasing.

One known dual-tipped stylus device has a tip end portion that is “passive” and an eraser end portion that is active, using a printed circuit board (PCB) with interlaced contacts that is shorted by a rubber dome with a conductive pad when contact is made with the surface of an electronic host device. This limits the range of angles for actuation and number of functionalities that can be implemented by such a stylus device.

Accordingly, a need exists for methods and apparatus for implementing “active” dual tip functionality on stylus devices for electronic host devices such as electronic tablets.

### SUMMARY

In some embodiments, an apparatus includes a first tip member and a second tip member coupled to opposite ends of a body. The first tip member and the second tip member are each be operable to be detected by a host device. A first conductive element is coupled to the body and configured to be selectively electrically coupled to the first tip member. A gap defined, at least in part, by the first tip member and the first conductive element can electrically isolate the first conductive element from the first tip member when the first tip member is in an unbiased configuration. The first conductive element can be electrically coupled to the first tip member when the first tip member is in a biased configuration. A second conductive element can be configured to be selectively electrically coupled to the second tip member. A communications module can be coupled to the body and operable to send a first signal to the host device when the first tip member is electrically coupled to the first conductive element and a second signal with the second tip member is electrically coupled to the second conductive element.

### BRIEF DESCRIPTION OF THE DRAWINGS

FIG. 1 is a system block diagram of a stylus device with two end portions, according to an embodiment.

FIG. 2 is a schematic illustration of a switch circuit diagram, according to an embodiment.

FIG. 3A-3D are cross-sectional views of two end portions of a stylus device, according to an embodiment.

FIG. 4 is an isometric phantom view of a first end portion of a stylus device, according to an embodiment.

FIG. 5 is an isometric phantom view of a second end portion of the stylus device of FIG. 4.

FIG. 6 is an isometric phantom view of a first end portion of a stylus device, according to an embodiment.

FIG. 7 is an isometric phantom view of a first end portion of a stylus device, according to an embodiment.

FIG. 8 is an enlarged isometric phantom view of the first end portion of the stylus device of FIG. 7.

FIG. 9 is an exploded perspective view of the first end portion of the stylus device of FIGS. 7 and 8.

FIGS. 10A-10C are cross-sectional views of the first end portion of the stylus device of FIGS. 7-9.

### DETAILED DESCRIPTION

In some embodiments, an apparatus includes a stylus device that includes a wireless transceiver and switches embedded at each end portion of the stylus device that distinguishes which end portion of the stylus device is in physical contact with an electronic host device (e.g., an electronic tablet). In such embodiments, the stylus device is configured to implement dual tip functionality such as, for example, a tip end portion for writing and/or drawing and an eraser end portion for erasing. In such embodiments, the two end portions of the stylus device can include conductive tip portions in various geometries (e.g., conductive elastomeric tip portions). Each conductive tip portion can, in a first configuration, form a closed circuit with a stationary conductive internal element to set the switch in the close configuration. Each conductive tip portion can, in a second configuration, form an open circuit with a stationary conductive internal element to set the switch in the open configuration. In other embodiments, tip portions may not be elastomeric. For example, the tip portions can be plastic, metal, and/or any other suitable material.

In some embodiments, an apparatus includes a first tip member and a second tip member coupled to opposite ends of a body. The first tip member and the second tip member are each operable to be detected by a host device. A first conductive element is coupled to the body and configured to be selectively electrically coupled to the first tip member. A gap defined, at least in part, by the first tip member and the first conductive element can electrically isolate the first conductive element from the first tip member when the first tip member is in an unbiased configuration. The first conductive element can be electrically coupled to the first tip member when the first tip member is in a biased configuration. A second conductive element can be configured to be selectively electrically coupled to the second tip member. A communications module can be coupled to the body and operable to send a first signal to the host device when the first tip member is electrically coupled to the first conductive element and a second signal with the second tip member is electrically coupled to the second conductive element.

In some embodiments, an apparatus includes an electronic circuit system operable to detect when either of two ends of a stylus is in contact with a surface. The electronic circuit system can include two circuits, a first circuit associated with a first end of the stylus, and a second circuit associated with a second end of the stylus. The first circuit can include a first conductive element and a first tip member collectively defining a first switch. The first switch can be biased in an open configuration. The first switch can move from the open configuration to a closed configuration when the first tip member deforms in response to contacting the surface. For example, when the first tip member contacts the surface, the first tip member can deform such that a gap between the first tip member and the first conductive member is closed. For example, when the first tip member deforms more than a threshold amount, the first tip member can contact the first conductive member. The second circuit can include a second conductive element and a second tip member collectively defining a second switch. The second switch can be biased in an open configuration. The second switch can move from its open configuration to a closed configuration when the second tip member deforms in response to contacting the surface. A communications module operatively coupled to the electronic circuit system can be configured to send a first signal to a host device when the first switch is closed and to send a second signal to the host device when the second switch is closed.

In some embodiments, a method can include detecting, at an electronic circuit system and at a first time that a switch associated with a first end of a dual-tipped stylus moves from an open configuration to a closed configuration. The switch associated with the first end of the dual-tipped stylus can move to its closed configuration when a first tip member deforms at least a threshold amount in response to contacting a surface to contact a conductive element. A first signal can be sent to a host device in response to detecting the first switch moving to its closed configuration. A second switch associated with a second end of the dual-tipped stylus moving from an open configuration to a closed configuration can be detected at a second time. A second signal can be sent to the host device in response to detecting the second switch moving to its closed configuration.

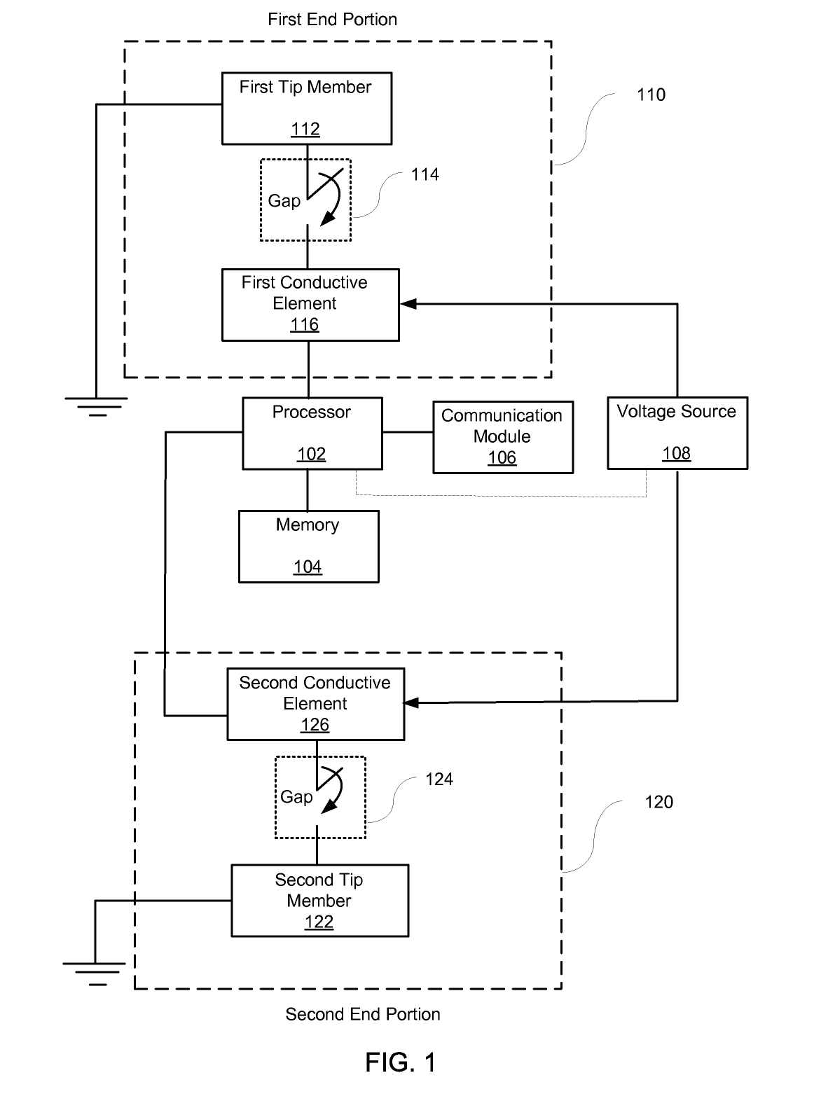

FIG. 1 is a system block diagram of a stylus device with a first end portion 110 and a second end portion 120, according to an embodiment. In some configurations, the first end portion 110 can be associated with, for example, a writing and/or drawing tip. In such configurations, the second end portion 120 of the stylus device can be associated with, for example, an eraser end. The first end portion 110 includes a first tip member 112, which can be, for example, a conductive elastomeric tip member that can be at least partially external to a body (not shown in FIG. 1) of the stylus. The first tip member 112 can also be referred to as an external conductive member. In some embodiments, the first tip member 112 can be entirely external to the body of the stylus.

The first end portion 110 can include a first conductive element 116 (also referred to herein as a conductive member and/or internal conductive element/member) separated from the first tip member 112 by a gap 114. Similarly stated, the first tip member 112 and the first conductive element 116 can define, at least in part, the gap 114. The first conductive element 116 can be at least partially internal to the body of the stylus. In some embodiments, the first conductive element 116 can be entirely internal to the body of the stylus.

The first tip member 112 can be deformable (e.g., an elastomeric tip can bend and/or flex) when the end portion is in contact with a surface of a host device (not shown). When the first tip member 112 deforms, the gap 114 can close and the first tip member 112 can make contact with the conductive element 116. Similarly stated, when the first tip member 112 deforms more than a threshold amount (e.g., more than the size of the gap 114) the first tip member 112 can contact the conductive element 116.

The second end portion 120 can be structurally and/or functionally similar to the first end portion 110. For example, the second end portion 120 can include a second tip member 122 and a second conductive member 126 that can define, at least in part, a second gap 124. The second tip member 122, the second conductive member 126, and/or the second gap 126 can each be structurally and/or functionally similar to the first tip member 112, the second conductive member 116, and/or the gap 116, respectively. In some embodiments, the second end portion 120 can be functionally similar to the first end portion 110, but one or more of the second tip member 122, the second conductive element 126 and/or the gap 124 can have different sizes, shapes, and/or dimensions. For example, the first end portion 110 can resemble and/or be analogous to a marking tip of a writing implement and/or the second end portion 120 can resemble and/or be analogous to an erasing implement.

The stylus can include a processor 102, a memory 104, a communication module 106, and a voltage source 108 each operably coupled to each other and/or the first end portion 110 and/or the second end portion 120. For example, the processor 102, the memory 104, the communication module 106, and/or the voltage source 108 can each be disposed within the body separating the first end portion 110 and the second end portion. The processor 102, the memory 104, the voltage source 108 and, optionally, the communication module 106 can collectively be referred to as an electronic circuit system. The electronic circuit system can further include a circuit associated with the first end portion 110 including a switch defined by the first tip member 112 and the first conductive element 116, and a circuit associated with the second end portion 120 including a switch defined by the second tip member 122 and the second conductive element 126.

The processor 102 can be a general purpose processor, a Field Programmable Gate Array (FPGA), an Application Specific Integrated Circuit (ASIC), a Digital Signal Processor (DSP), and/or the like. The processor 102 can be configured to run and/or execute processes and/or functions associated with the dual-tipped stylus device. The processor 102 is operably coupled to the memory 104. The memory 104 can be, for example, a random access memory (RAM), a memory buffer, a database, an erasable programmable read-only memory (EPROM), an electrically erasable read-only memory (EEPROM), a read-only memory (ROM) and/or so forth. The memory 104 can store instructions to cause the processor to execute processes and/or functions associated with the dual-tipped stylus device. The communication module 106 can be can be software (e.g., stored in memory 104 and/or executing on the processor 102) and/or hardware associated with, for example, a Bluetooth® radio, a ZigBee® module, a wired and/or wireless Network Interface Controller (NIC), a Universal Serial Bus (USB)™, an ultrasonic, magnetic and/or any other suitable module configured to send and/or receive signals.

For example, when a specific end portion of the stylus device (e.g., the first end portion 110 or the second end portion 120) is in contact with the surface of a host device, for example, during writing or drawing or erasing, force is applied to a tip member (e.g. the first tip member 112 or the second tip member 122). The tip member can deform (i.e., change configuration) and come into physical and/or electrical contact with the conductive member (e.g., the first conductive member 116 and/or the second conductive member 126) closing a gap (e.g., the gap 114 or 124), allowing current to flow from a voltage source 108 (e.g. a battery, capacitor, AC voltage source, etc.). Similarly stated, deformation of the tip member can move a switch to a “closed” configuration with regards to the end portion of the stylus device that is in contact with the host device surface. The processor 102 can detect the closed switch. In some embodiments, the first end portion 110 and the second end portion 120 can be connected to different input pins (or channels) of the processor 102, the processor 102 can identify which switch is closed. The processor 102 can send a signal to the communication module 106 to cause the communication module 106 to send a signal, for example, to the host device. For example, the communication module 106 can send a first signal if the switch associated with the first end portion 110 is closed and a second signal if the switch associated with the second end portion 120 is closed. In some embodiments, the communication module 106 can wirelessly “pair” the stylus to the host device and/or can periodically and/or substantially continuously send signals to the host device such that the host device can identify when a switch is closed in substantially real time. Similarly stated, the communication module 106 can be operable to identify the “active” end portion of the stylus device that is being used by the user and/or to keep the host device informed of which end of the stylus is active.

The first tip member 112 and the second tip member 122 can each be biased towards a first (e.g., undeformed) configuration. When the first tip member 112 and/or the second tip member 122 are not in contact with a surface (e.g., the surface of a host device), the first tip member 112 and/or the second conductive member 122 can be spaced apart (e.g., not in physical and/or electrical contact) from the first conductive element 116 and/or the second conductive element 126, respectively. Hence, the first gap 114 and/or the second gap 124, respectively, remains open such that an electric circuit associated with the first end portion 110 and/or the second end portion 120, respectively is open. The processor 102 can detect when the first gap 14 and/or the second gap 124 is open such that the processor 102 does not cause the communication module 106 to identify the open end portion of the stylus as active. In some embodiments, the processor 102 may not cause the communication module 106 to send a signal identify one end portion of the stylus device as active if the other end of the switch associated with the other end portion of the stylus device is closed. For example, if the user is applying a writing end portion of the stylus device and manually presses on the eraser end portion, the processor 102 may not identify the eraser end portion as active. Similarly stated, when a switch is closed, the processor 102 can be operable to identify an end portion of the stylus device associated with that switch as active only if the switch associated with the other end portion is open.

In some embodiments, each end portion of the stylus device can implement multiple functionalities. In such embodiments that include multiple functionalities at each end portion of the stylus device, a separate activation mechanism can exist for each functionality, so that a user can select one functionality from two or more possible choices for a given end portion of the stylus device. For example, the first conductive element 116 and/or the second conductive element 126 can be subdivided into multiple conductive elements. The processor 102 can be operable to detect which portion of the conductive element 116, 126 is contacted by the tip member 112, 116.

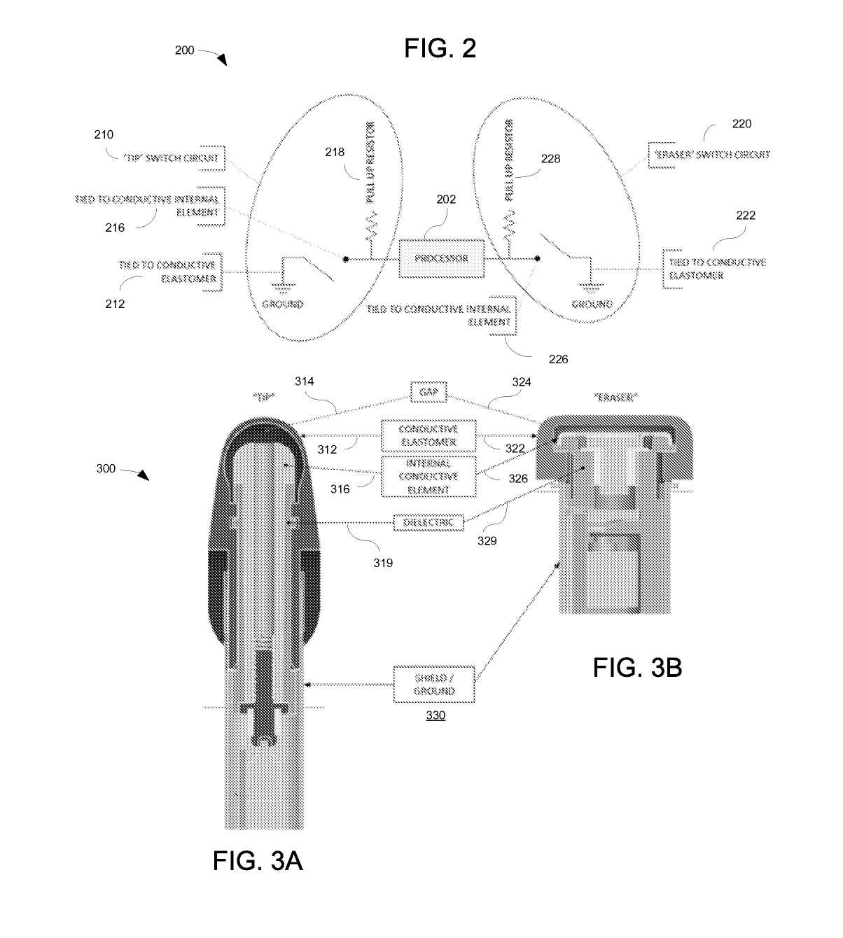

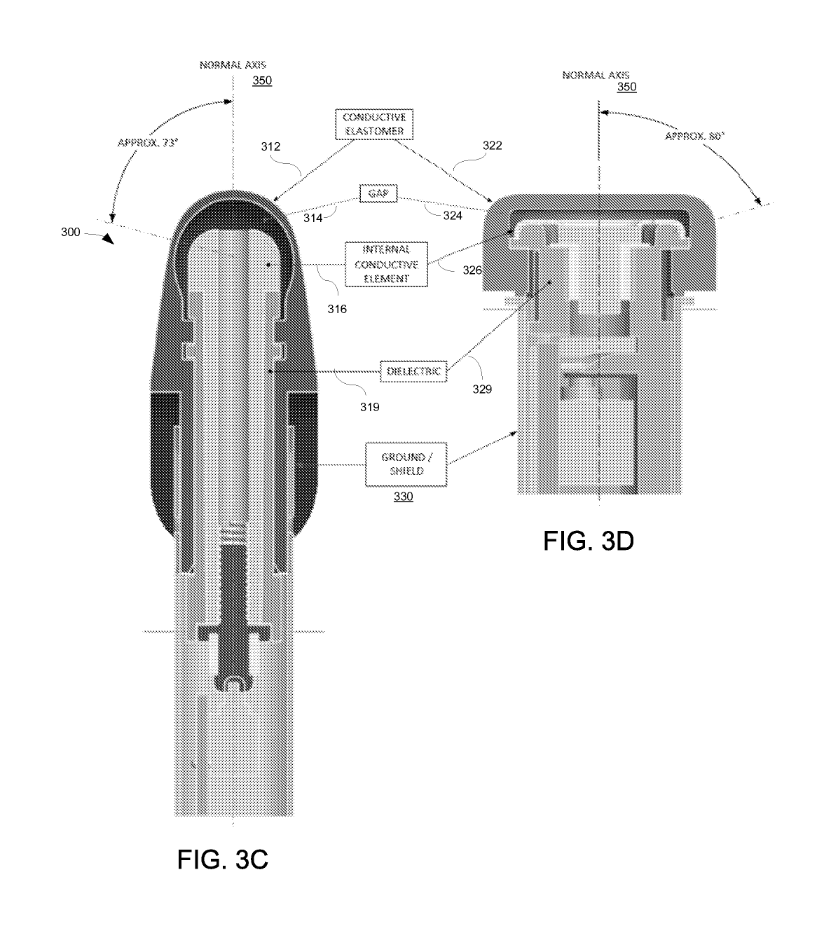

FIGS. 3A to 3D are cross-sectional views of a stylus device 300, according to an embodiment. FIGS. 3A and 3C are cross-sectional views of a “tip” portion of the stylus device 300. FIGS. 3B and 3D are cross-sectional views of an “eraser” portion of the stylus device. The stylus device 300 can include an electronic circuit, such as the circuit 200 shown in FIG. 2. The electronic circuit 200 is discussed in conjunction with the stylus device 300.

The stylus device 300 can be operable to be used with a variety of different host devices manufactured by different manufacturers such as, for example, the Apple iPad®, the Samsung ATIV Smart PC®, the Samsung Galaxy®, the Amazon Kindle Fire®, the Toshiba Excite®, and/or the like. Hence, prior to usage, the stylus device can first establish a communication link between the stylus device and the host device (e.g., electronic tablet). Similarly stated, the stylus device can pair with the host device. In some configurations, a communication link can be established between the stylus device 300 and the host device by sending a set of wireless configuration setup signals from the wireless transceiver of the stylus device 300 to the host device and receiving a set of wireless confirmation signals from the host device at the wireless transceiver of the stylus device 300. In some instances, the host device can be installed with appropriate software that can allow the host device to send and receive signals from the stylus device 300. The wireless transceiver of the stylus device 300 can connect with the host device using any wireless communication technology such as, for example, Institute of Electrical and Electronics Engineers (IEEE) 802.11x Wi-Fi®, Bluetooth®, or other wireless communication technology. Upon establishing successful communication between the stylus device 300 and the host device, the stylus device 300 can be ready to be used by the user.

In the embodiment shown in FIG. 3A-3D, one end portion of the stylus device is the writing and/or drawing tip (310 and as shown in FIGS. 3A and 3C), also referred to herein as a distal end or distal end portion, and the other end portion of the stylus device is the eraser (320 and as shown in FIGS. 3B and 3D), also referred to herein as a proximal end or proximal end portion. Each end portion of the stylus device 300 includes an external conductive surface (also referred to herein as an external conductive element, external conductive member or tip member) 212, 222, 312, 322 made of, for example, an elastomer (e.g., rubber) and an internal conductive element (or member) 216, 226, 316, 326. The external conductive surface 212, 222, 312, 322 is external to the internal conductive element 216, 226, 316, 326. In some embodiments, the external conductive surface 212, 222, 312, 322 can be partially and/or entirely external to a body or case of the stylus device. In some embodiments, the internal conductive element 216, 226, 316, 326 can be partially and/or entirely internal to the body of the stylus device. As shown in FIGS. 3A and 3C, the gap 314 of the distal end portion of the stylus device 300 can be entirely distal of the body of the stylus device 300. Similarly, as shown in FIGS. 3B and 3D, the gap 324 of the proximal end portion of the stylus device 300 can be entirely proximal of the body of the stylus device 300.

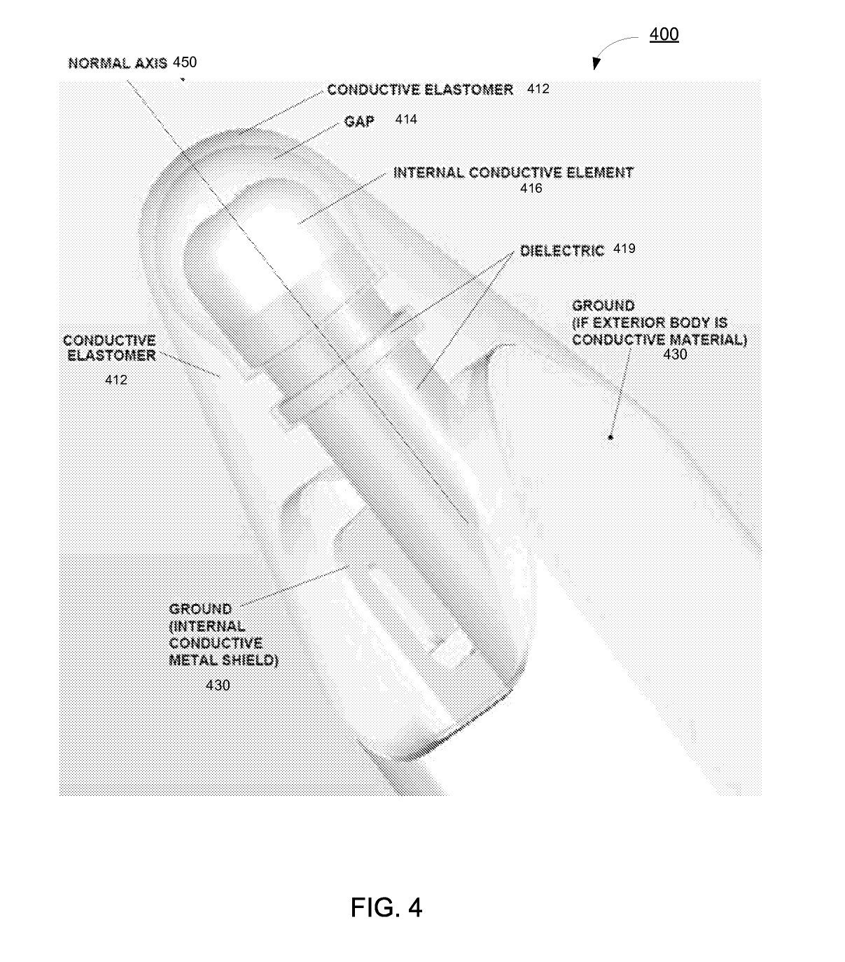

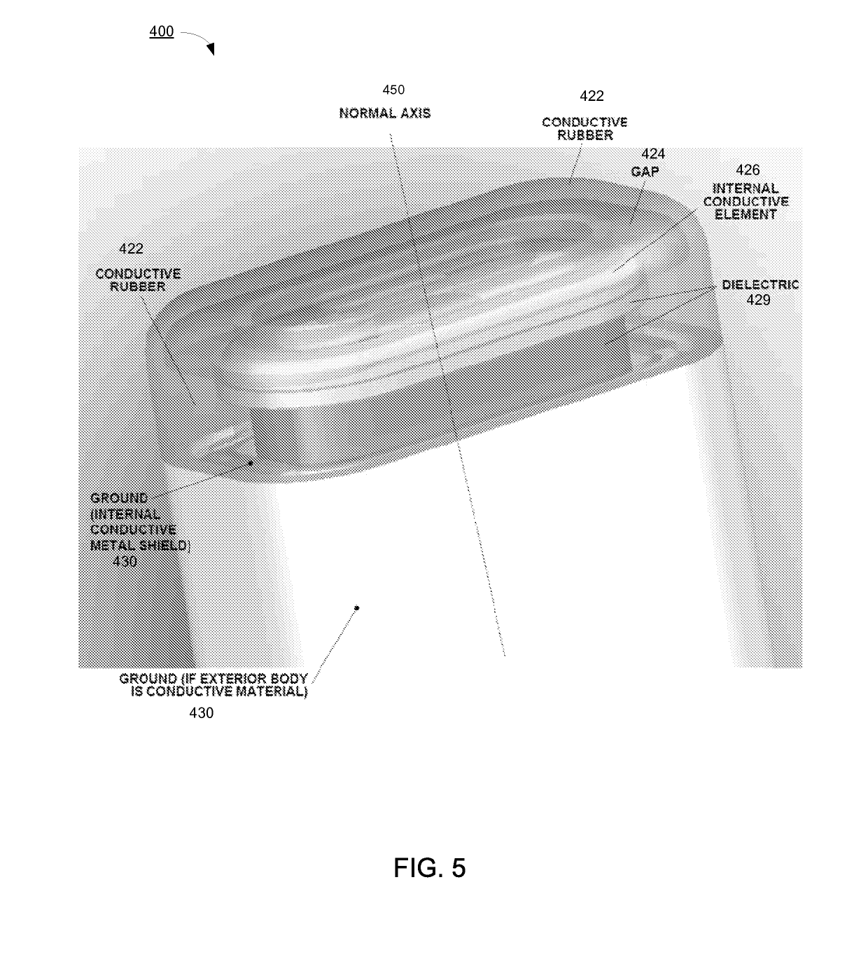

The external conductive surfaces 212, 222, 312, 322 can be movable and/or deformable relative to the rest of the stylus device and/or the internal conductive elements 212, 222, 312. 322. In some embodiments, the internal conductive element 212, 222, 312, 322 can be stationary relative to the rest of the stylus device. Each of the external conductive surfaces 212, 222, 312, 322 and each of the internal conductive elements 216, 226, 316, 326 can be connected to separate signal lines in the circuit as shown in FIG. 2. In some embodiments, the external conductive surfaces 212, 222, 312, 322 are coupled to the ground of the stylus device 200, 300. In some embodiment, the case (or body) of the stylus device 200, 300 can be the ground, for example in embodiments where the case is constructed of a conductive material (as shown, for example, in FIG. 5). In other embodiments, an internal shield can be the ground (as shown, for example, in FIG. 4).

In some embodiments, the stylus device 200, 300 can include a dielectric layer 319, 329, which can prevent the internal conductive element 216, 226, 316, 326 from being connected to the ground when the respective end portion of the stylus device 200, 300 is not in use. When an end portion of the stylus device 200, 300 is not in contact with the surface of the host device (as shown in FIG. 2), the external conductive surface 212, 222, 312, 322 is not in physical or electrical contact with the internal conductive element. Hence, the electrical circuit for that end portion is an open circuit and the switch for that end portion in the open or “passive” configuration as seen in FIG. 2.

The external conductive element 212, 222, 312, 322 can be made of an elastomer material. In such embodiments, when force is applied to the external conductive element 212, 222, 312, 322 for a given end portion when that external conductive element is in contact with the host device surface, for example, during writing or drawing or erasing, the external conductive element 212, 222, 312, 322 can deform (i.e., change configuration, for example, from an unbiased configuration to a biased configuration) and move into physical and electrical contact with the stationary internal conductive element 216, 226, 316, 326. Similarly stated, the external conductive element 212, 222, 312, 322 can deform to close the gap 314, 324. Thus, when the external conductive element 212, 222, 312, 322 deforms more than a threshold amount (e.g., an amount sufficient to close the gap 314, 324), the external conductive element 212, 222, 312, 322 can move into physical and/or electrical contact with the internal conductive element 216, 226, 316, 326. This produces a closed circuit that can allow current to flow from a voltage source (not shown in FIG. 2). The voltage source can be for example, an AAA battery, a lithium polymer battery, a solar panel voltage source, and/or the like. In some embodiments, elastic deformation of the external conductive element 212, 222, 312, 322 can close the circuit (e.g., move a switch into a closed configuration) without other moving parts.

When an end portion 210, 220 of the stylus device 200, 300 is actuated, a switch associated with that end portion can be moved to a closed configuration. As discussed in FIG. 1, the activated switch can be detected by a processor 202 that can cause a wireless signal to be sent, for example, via a wireless transceiver to the host device that identifies the “active” end portion of the stylus device 200, 300. In the opposite end portion of the stylus device (not in contact with the host device surface), the switch remains in the “open” configuration and no electrical contact exists between the external conductive surface and the internal conductive element. The processor 202 can similarly detect the “open” configuration. Thus, the processor 202 can be operable to distinguish which end portion of the stylus device is in contact with the host device surface (e.g., electronic tablet surface) and can thus enable multi-tip functionality (e.g., writing/drawing tip and erasing). A pull up resistor 218, 228 can be used to control the current levels within the stylus device 200, 300 and can prevent accidental short circuits from occurring that can damage the stylus device 200, 300.

In other embodiments, such as an embodiment where the external conductive surface is not made of an elastomeric material, a pressure sensor can, for example, be incorporated in the external conductive surface. In such embodiments, the processor can be operable to detect when the pressure sensor registers a pressure associated with contact with a surface (e.g., a pressure greater than a threshold value).

In some embodiments, when the external conductive element 212, 222, 312, 322 is moved (e.g., deformed and/or moved into a biased configuration) into contact with the internal conductive element 216, 226, 316, 326, the processor 202 can be operable to measure or determine a pressure. For example, the internal conductive element 216, 226, 316, 326, and/or the external conductive element 212, 222, 312, 322 can be operable to modulate the voltage passed via the switch to the processor 202. Similarly stated, the switch can be operable to enable resistive pressure sensing. The measured or determined pressure can be used to adjust a displayed line thickness, darkness, etc. In other embodiments, the external conductive element 212, 222, 312, 322 and the internal conductive element 216, 226, 316, 326 (individually or collectively) can enable the processor 202 to determine a pressure and/or a force applied to an end portion 210, 220 of a stylus device 200, 300 through capacitive, inductive, strain-based, load-cell, piezo, and/or any other suitable detection or sensing technologies.

As shown in FIGS. 3C and 3D, the external conductive element 312, 322 can be operable to deform to close the gap 314, 324 and contact the internal conductive element 316, 326 over a wide range of positions (or angles relative to the host device). Similarly stated, the stylus device 300 can be operable to be used in a wide variety of ergonomic positions and/or for a wide variety of operations (e.g., substantially vertically for fine detail work and with a large angle from normal axis 350 for broad shading). The arraignment of the external element 312, 322 and the internal conductive element 316, 326 and/or the size of the gap 314, 324 can enable the stylus device 300 to detect when an end portion is using a non-axial sensor. In this way, the force used to activate an end portion of the stylus device 300 can be pre-configured and/or can decrease at large angles from normal 350 such that typical writing forces are suitable to actuate an end portion. For example, the end portion shown in FIG. 3C can be activated at a wide range of angles (up to, for example, approximately 73°) about the normal axis 350.

The gap 314, 324 between the external conductive element 312, 322 and the internal conductive element 326, 326 for the tip end portion (as shown, for example, in FIG. 3C) is not uniform but rather is smaller for larger angles from the normal axis 350. The force used to activate an end portion of the stylus device 300 can be a function of the elastic modulus of the external element 312, 322 and the size of the gap 314, 324. Thus, the stylus device 300 can be designed such that a particular force is used to actuate each end 310, 320 of the stylus device 300 and/or such that a particular force is used to actuate each end 310, 320 of the stylus device 300 at a particular angle. For example, a larger force may be used to actuate an end 310, 320 of the stylus device when the stylus device is held at an angle substantially parallel to the normal axis than is used t actuate an end 310, 320 at a larger angle from the normal axis 350 (e.g., if the gap 314, 324 is smaller at larger angles from the normal axis 350). Additionally, the gap 314, 324 between the external conductive element 312, 322 and the internal conductive element 316, 326 can also be smaller in size at the angles typically used during writing and/or drawing. Hence, the shape and performance of the end portions of the stylus device 300 can correlate to the ergonomics of a typical users hand and thus can allow for ease and comfortable use. The “responsiveness” of the stylus 300 to pressure can be relatively high.

In some embodiments, the end portion of the stylus device 300 shown in FIGS. 3A and 3C can be analogous to a writing end of a pencil, while the end portion of the stylus device 300 shown in FIGS. 3B and 3D can be analogous to an eraser end of a pencil. The eraser end can function and/or be configured similarly to the writing end portion. For example, the eraser end portion can be activated by a relatively low actuation force across a desired angular range. The shape and performance of the eraser end portion can, in some instances, correlate to the ergonomics of a typical user when using an eraser, where such an eraser is often used at angles that are substantially perpendicular to the surface of a host device (i.e., at angles that are parallel to or substantially parallel to the normal axis 350).

The external conductive surface 326 and the internal conductive element 316 can be substantially flat and/or rectangular structures. In such embodiments, the gap 314 between the external conductive surface and the internal conductive element can be substantially uniform across the surface of the structures 316, 326 and/or the gap 314 can be only slightly larger at the corners of the end portion as compared to the center of the end portion. Thus the “responsiveness” of the eraser end portion of the stylus device to pressure can also be relatively high. For example, the end portion shown in FIG. 3D can be activated at a wide range of angles (up to, for example, approximately 80°) about the normal axis 350.

Additionally, in some instances, a large surface area (e.g., relative to the surface area of the writing end) of the eraser tip portion can be desired for increased erasing efficiency. In such instances, the shape and performance of the eraser end portion of the stylus device as seen in FIGS. 3B and 3D can also correlate to the ergonomics of a typical user when erasing. In such instances, the relatively small gap between the external conductive surface and the internal conductive element is present at angles substantially parallel to the normal axis 350. This can allow for a relatively low actuation force to “activate” the eraser end portion of the stylus device 300 in the desired angular range. In embodiments in which the eraser end portion is rectangular and/or flat, the amount of the external element 322 in contact with the screen of the host device can decrease as the stylus 300 is tilted from the normal axis 300. As the area of the external element 322 in contact with the screen of the host device decreases, the host device may register a narrower contact patch. Since the host device may be operable to modify a graphical user interface (GUI) based on the size of an implement contacting the display, presenting a larger area to the display (e.g., when the eraser end is substantially vertical) may allow for “efficient” erasing. Conversely, when the eraser end is tilted off of its normal axis 350, a smaller contact patch may be presented to the screen of the host device such that a smaller portion of the GUI is modified as the stylus device 300 is moved across the screen.

FIGS. 4 and 5 are isometric phantom views of two end portions of a stylus device 400. The end portion of the stylus device 400 shown in FIG. 4 can be referred to as “a tip end portion,” while the end portion of the stylus device 400 shown in FIG. 5 can be referred to as “an eraser end portion” of the stylus device. Similarly stated, the end portion of the stylus device 400 shown in FIG. 4 can be a distal end portion of the stylus device 400, while the end portion of the stylus device 400 shown in FIG. 5 can be a proximal end portion of the stylus device. The end portion of stylus 400 shown in FIG. 4 can be functionally similar to the end portion of stylus device 300 shown in FIGS. 3A and 3C. The end portion of stylus 400 shown in FIG. 5 can be functionally similar to the end portion of stylus 300 shown in FIGS. 3B and 3D.

As shown in FIG. 4, the stylus device includes an external conductive element 412 (which can be constructed of and/or referred to as a conductive elastomer), an internal conductive element 416 (which can also be referred to as a stationary conductive element), a dielectric 419, and a ground 430. The external conductive element 412 and the internal conductive element 416 can collectively define a gap 414. The gap 414 is disposed entirely distal of the body. The internal conductive element 416 can be at least partially disposed within the body and/or electrically coupled to a conductor that is at least partially disposed within the body. The internal conductive element 416 can be electrically isolated from the body 430 of the stylus 400 (which can be, in some embodiments, an electrical ground) by a dielectric 419.

As described above, the external conductive element 412 can be constructed of an elastomeric material biased in a configuration such that the gap 414 electrically and/or physically separates the external conductive element 412 from the internal conductive element 416. When the external conductive element 412 is placed in contact with a surface (e.g., a touch-sensitive surface of a host device), the external conductive element 412 can deform towards the internal conductive element. When the external conductive element deforms a sufficient (i.e., a threshold) amount, it can physically and/or electrically contact the internal conductive element 416, which can close a circuit and/or switch and be detected by a processor (not shown in FIG. 4) such that the stylus device 400 can send a signal to the host device indicating that an end of the stylus device 400 shown in FIG. 4 (e.g., a writing end) is active.

The stylus device 400 can be actuated when a light actuation force is applied by a user across a wide range of contact angles between the distal end portion of the stylus device 400 and the surface of the host device. The force used to actuate the distal end portion of the stylus device 400 can be a function of the elasticity of the conductive element 412 and/or the size of the gap 414. The external conductive element 412 has a non-uniform thickness which can also influence the force used to actuate the distal end portion of the stylus device 400. The force used (e.g. the minimum force used) to actuate the distal end portion of the stylus device 400 can be angular-dependent and/or non-uniform (e.g., with respect to the normal axis 450) Furthermore, as shown in FIG. 4, an internal surface of the external conductive element 412 and an external surface of the internal conductive element 416 are rounded. Similarly stated, the internal conductive surface of the external conductive element 412 and/or the external surface of the internal conductive element 416 can be spherical/hemispherical. Thus the gap 414 or a portion of the gap 414 can have the shape of or similar to a lamina of a portion of sphere. Because the size of the gap 414 can influence the force to actuate the distal end of the stylus device 400, a uniform and/or non-uniform gap size (e.g., as defined by complementary/non-complementary shapes of the internal conductive element 416 and the external conductive element 412) the forced used to actuate the distal end of the stylus device 400 can be “tuned” or pre-configured based, for example, on an angle from the normal axis 450. The tuned force can be informed, for example, by ergonomics and/or any other suitable concerns.

As shown in FIG. 5, the stylus device 400 includes an external conductive element 422 (which can be constructed of and/or referred to as a conductive elastomer), an internal conductive element 426 (which can also be referred to as a stationary conductive element), a dielectric 429, and a ground 430. The external conductive element 422 and the internal conductive element 426 can collectively define a gap 424. The gap 424 is disposed entirely proximal of the body. The internal conductive element 426 can be at least partially disposed within the body and/or electrically coupled to a conductor that is at least partially disposed within the body. The internal conductive element 426 can be electrically isolated from the body 430 of the stylus 400 by the dielectric 429. The external conductive element 422 is substantially flat and the cross-section of the external conductive element 422 is rectangular in shape. The shape and/or cross section of the internal conductive element 426 can at least partially correspond to the shape and/or cross section of the external conductive element 422.

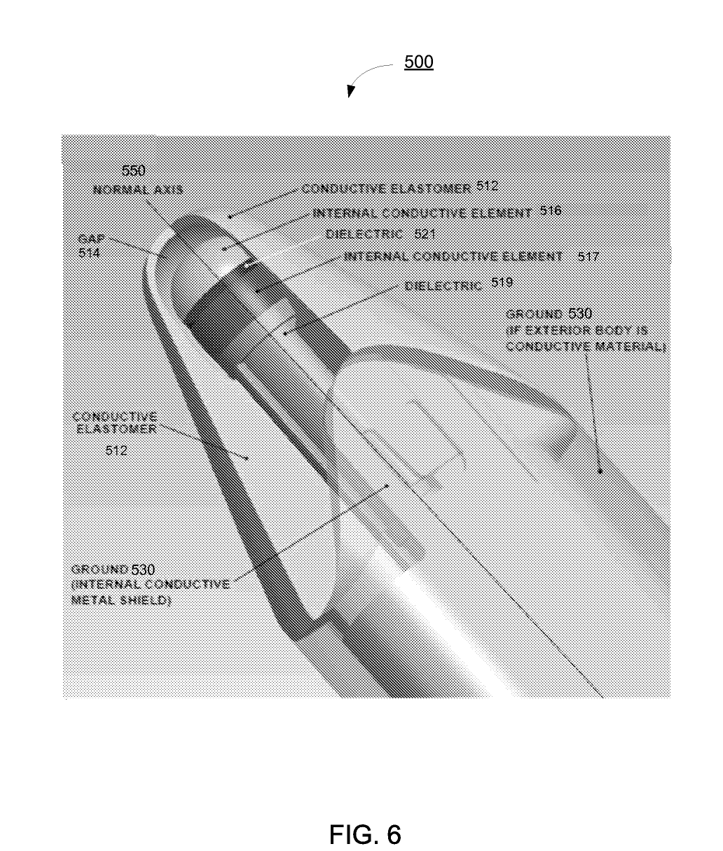

FIG. 6 is an isometric phantom view of an end portion of a stylus device 500. The end portion of the stylus device 500 shown in FIG. 6 can be referred to as a tip end portion or a distal end portion. The end portion of stylus 500 shown in FIG. 6 can be functionally similar to the end portion of stylus device 300 shown in FIGS. 3A and 3C. The stylus device 500 includes an external conductive element 512, and a first internal conductive element 516, which collectively define a gap 514. The external conductive element 512, the first internal conductive element 516, and the gap 514 can each be structurally and/or functionally similar to the external conductive element 412, the internal conductive element 416, and/or the gap 414, respectively, as shown and described above with reference to FIG. 4. In addition, the stylus device 500 includes a first dielectric 519, which can electrically isolate the first internal conductive element 516 from an electrical ground 530 (e.g., a conductive body of the stylus device 500 and/or an internal ground). The first dielectric 519 and/or the ground 530 can be structurally and/or functionally similar to the dielectric 419 and/or the ground 430, respectively.

Stylus device 500 further includes a second internal conductive element 517. The second internal conductive element 517 can be separated (e.g., electrically and/or physically) from the first internal conductive element 516 via a second dielectric 521. Each of the first internal conductive element 516 and the second internal conductive element 517 can be separated from the external conductive element 512 by the gap 514. The second internal conductive element 517 can be toroidal and/or cylindrical in shape. A processor (not shown in FIG. 6) can be operable to detect when the external conductive element 512 contacts the first internal conductive element 516 and/or the second internal conductive element 517.

The processor can be operable to detect different patterns associated with the distal end portion of the stylus 500 contacting a surface. For example, a first “zone” of the stylus 500 can be activated when the external conductive element 512 contacts the first internal conductive element 516 but not the second internal conductive element 517, a second zone can be activated when the external conductive element 512 contacts both the first internal conductive element 516 and the second internal conductive element 517, and a third zone can be activated when the external conductive element 512 contacts the second internal conductive element 517 but not the first internal conductive element 516. Each zone can be associated with a different contact angle and/or use case. For example, the second zone can be associated with larger angles of incidence (e.g., angles greater from the normal axis 550) than the first zone; the third zone can be associated with greater angles of incidence than the second zone.

The presence of the second internal conductive element 517 and/or the ability of the processor to detect different zones being activated can allow the stylus device 500 to have added functionalities when the distal end portion of the stylus device 500 is in use. For example, the stylus device can be operable to send a signal to a host device via a communication module indicating which zone is active.

Thus, independent features or functionalities of the stylus device (e.g., draw, write, shade, etc.) associated with each zone of the internal stationary conductive element can be activated at different contact angles of the stylus device with, for example, a host device surface. Said in another way, a first functionality (e.g., writing) associated with the first zone of the internal stationary conductive element can be activated by holding the stylus device at a first angle with respect to the host device surface, and a second functionality (e.g., drawing) associated with the second zone of the internal stationary conductive element can be activated by holding the stylus device at a second angle with respect to the host device surface. A third feature or functionality of the stylus device (e.g., broad-stroked shading) can be activated by activating the third zone of the internal stationary conductive element.

The host device can be operable to react differently to the stylus based on which zone is active. For example, the host device can be operable to alter a GUI by adding a line of a first (e.g., fine) thickness when the stylus 500 is moved over a surface of the host device with the first zone active, adding a line of a second (e.g., medium) thickness when the stylus 500 is moved over the surface of the host device with the second zone active, and/or adding a line of a third (e.g., thick) thickness when the stylus 500 is moved over the surface of the host device with the third zone active.

While a specific embodiment of stylus device 500 is described above, it should be understood that it has been presented by way of example only, and not limitation. For example, in other embodiments, each zone of the first internal conductive element 516 and/or the second internal conductive element 517 can be divided into separate regions (e.g., each cylindrical or semi-cylindrical zone of the first internal conductive element 516 and/or the second internal conductive element 517 can be divided along the radius or diameter into any number of independent regions similar to “pie slices”. Contact of the stylus device 500 with the host device surface at different angles can independently activate the different regions (or switches) of the stylus device 500 and thus activate different functionalities of the stylus device 500. For another example, although certain zones are described as associated with or in conjunction with certain functionalities, in other embodiments, any zone can be associated with any suitable functionality.

In some embodiments, the first internal conductive element 516 and/or the second internal conductive element 517 can be divided into, for example, more than two separate zones (also referred to axial zones disposed along the normal axis 550 of the stylus device). Each zone of the internal conductive elements 516, 517 can also be further divided along the radius or diameter into independent regions. In such embodiments, a user of the stylus device 500 can activate a different region or a set of regions (each associated with a zone(s) of the internal stationary conductive element) depending on the angle of contact made between the stylus device 500 and the host device. In this way, the stylus device 500 can be operable to detect the radial orientation of the stylus device. In some such embodiments, orienting the stylus device 500 in different radial positions can be associated with different functionalities. For example, a color wheel can be associated with the stylus device 500 such that as the stylus device is rotated radially the stylus device 500 sends signals to the host device such that the color of a modification changes. As an illustration, if the stylus device 500 is held in a first radial orientation to make a red mark on a GUI of the host device, the color of the mark can be gradually changed to blue by rotating the stylus device 500 through 120° in a first direction or gradually changed to yellow by rotating the stylus device 500 through 120° in a second direction.

In some embodiments, the stylus device 500 can be operable to detect a pressure exerted by a user. In one such embodiment, the first internal conductive element 516 can be operable to move relative to the second internal conductive element 517 when a force is applied. For example, the dielectric 521 can be elastomeric or otherwise deformable. The first internal conductive element 516 can be operable to physically and/or electrically contact the second internal conductive element 517 when a threshold force is applied. For example, the dielectric 512 can be toroidal or otherwise allow the first internal conductive element 516 to contact the second internal conductive element 517 when deformed more than a threshold amount. A processor (not shown in FIG. 6) disposed, for example, within the stylus device, can be operable to detect when the first internal conductive element 516 is in physically and/or electrical contact with the second internal conductive element 517.

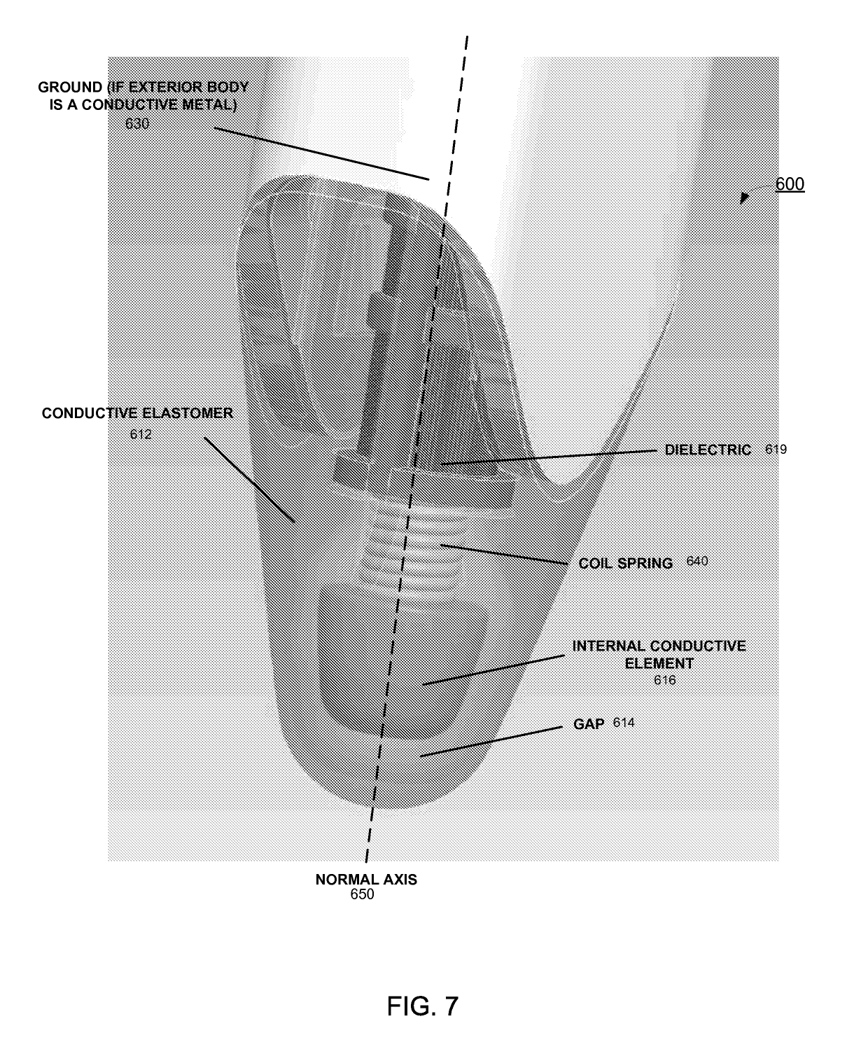

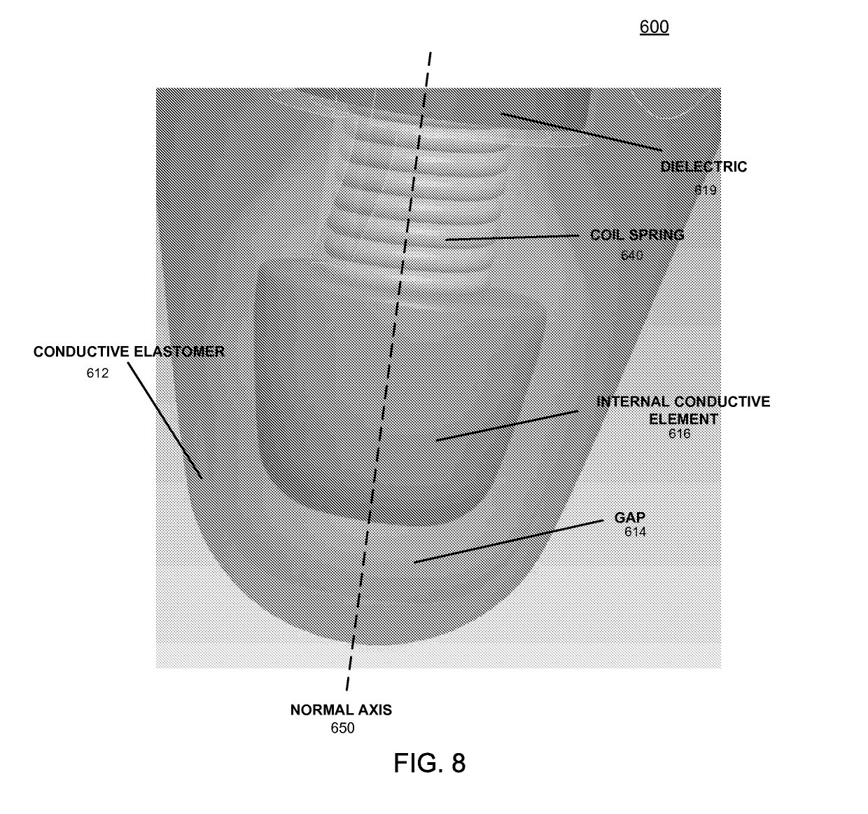

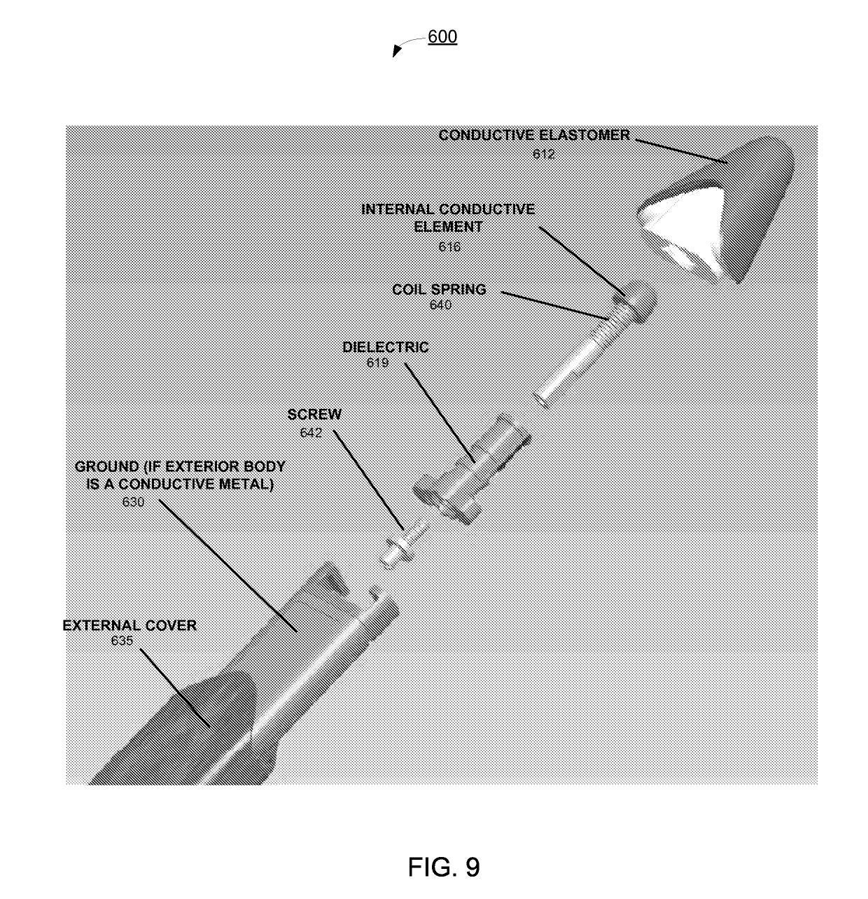

FIG. 7 is an isometric phantom view of the tip end portion of a stylus device 600, according to an embodiment. FIG. 8 is an enlarged isometric phantom view of the tip end portion of the stylus device 600, and FIG. 9 is an exploded perspective view of the tip end portion of the stylus device 600. In the embodiment of the stylus device 600 shown in FIGS. 7-9, a spring 640 couples an internal conductive element 616 to the dielectric 619, a body 630 of the stylus 600, and/or a processor (not shown). The stylus 600, an external conductive element 612, the internal conductive element 616, a gap 614, and the body 630 can each be structurally and/or functionally similar to similar components of other stylus devices described herein.

The spring 640 can be a closed coil spring. A closed coil spring 640 can be operable to flex primarily from side-to-side (not as much up-and-down). Similarly stated, the spring 640 can have a lower spring constant associated with lateral (or radial) forces than a spring constant associated with compressive (or axial) forces. The use of the spring 640 can lead to improved durability of the external conductive member 612 because the spring 640 can allow the internal conductive element 616 to deflect (or deform) across a wide range of contact angles (with respect to the normal axis 650) between the tip end portion of the stylus device 600 and the surface of the host device. This can reduce the pressure generated on the external conductive member 612 (interior part) from the repeated impact of the internal conductive member 616 on the external conductive member 612. Additionally, the spring 640 can absorb a portion of the force and/or energy transmitted between internal conductive element 616 and external conductive member 612 when the stylus 600 is in use (e.g., while writing or drawing on the surface of a host device). Hence, the inclusion of the spring 640 can significantly improve the durability of the stylus device 600 and reduce the amount of wear and tear of the external conductive member 612.

In addition, displacement of the internal conductive element 616 (e.g., laterally) can allow for a larger surface area of contact (or contact patch) with the external conductive member 612. This can decrease the pressure between the internal conductive element 616 and the external conductive member 612 further reducing wear and tear. The larger contact patch between the internal conductive element 616 and the external conductive member 612 can also result in a larger contact patch between the external conductive member 612 and the host device, which can allow for a faster touch event or a more sensitive response because the desired size of conductive elastomer tip contacting the host device surface occurs with less force and the internal conductive element 612 conforms to the flatness of the screen of the host device more efficiently. In addition or alternatively, the host device can be operable to detect the size of the contact patch between the external conductive member 612 and the screen of the host device. In some embodiments, the host device can be operable to calculate a force applied to the stylus device 600 and/or modulate a modification to a GUI based on the size of the contact patch. For example, a thickness of a line added to a GUI can be a function of the size of a contact patch between the external conductive member 612 and the screen.

Furthermore, the spring 640 can allow for a more reliable and consistent electrical connection between the internal conductive element 616 and the external conductive member 612, which can more effectively keep a circuit associated with the end portion of the stylus (see, e.g., FIG. 1) closed during a use of the stylus tip (e.g., during a stroke on the surface of the host device) because the external conductive member 612 can conform to a greater surface area of the internal conductive element 616 (due to bending via the spring 640). Hence, instead of a stiff or inflexible point contact between the external conductive member 612 and the internal conductive element 616 during use, the internal conductive element 616 can instead bend and settle horizontally against the surface of the host device. This allows the external conductive member 612 to “hug” or contact more of the internal conductive element 612 including the direct most surface of the internal conductive element 616 in addition to the adjacent (or proximal) surfaces of the internal conductive element 616.

Use of the spring 640 allows for a lower force(s) to be used to close the switch (tip) and thus register as a “touch” event on the surface of the host device. This can result in the user perception of increased sensitivity as the lower force(s) used to start a stroke can lead to more surface area contact faster and this can result in a “faster” touch event. Additionally, because less force is used to maintain a stroke due to the use of the spring 640, more reliability can be achieved with the different modulating forces involved in, for example, drawing and writing activities.

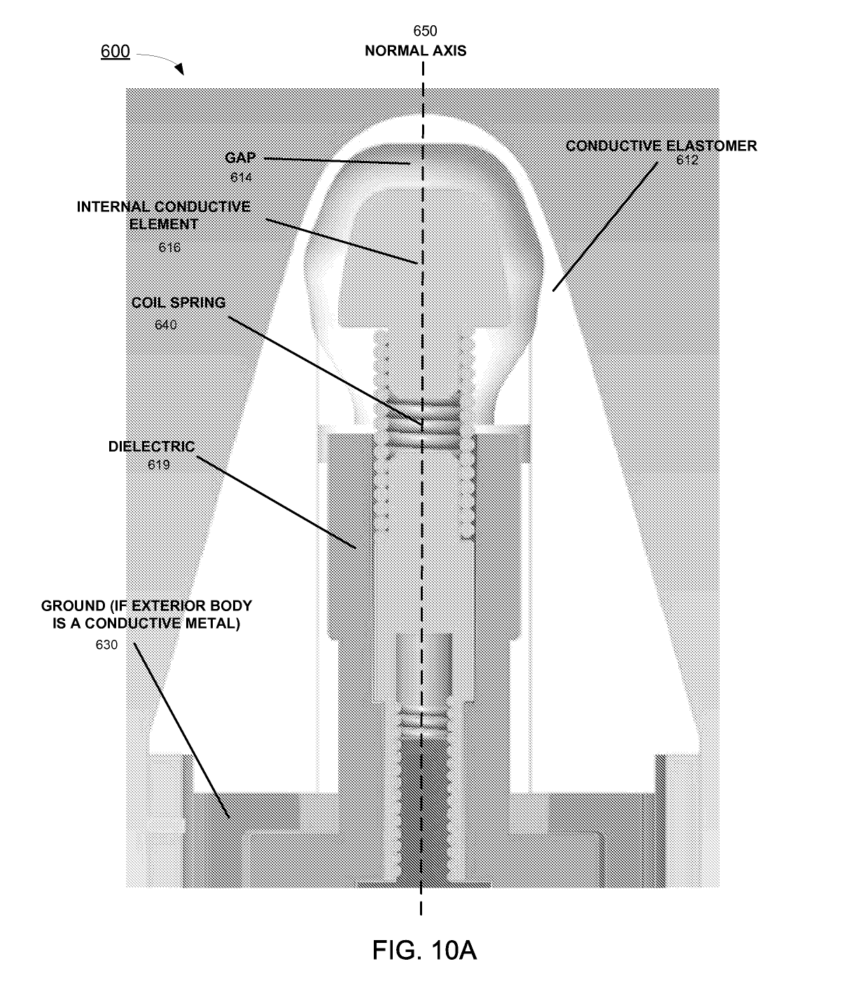

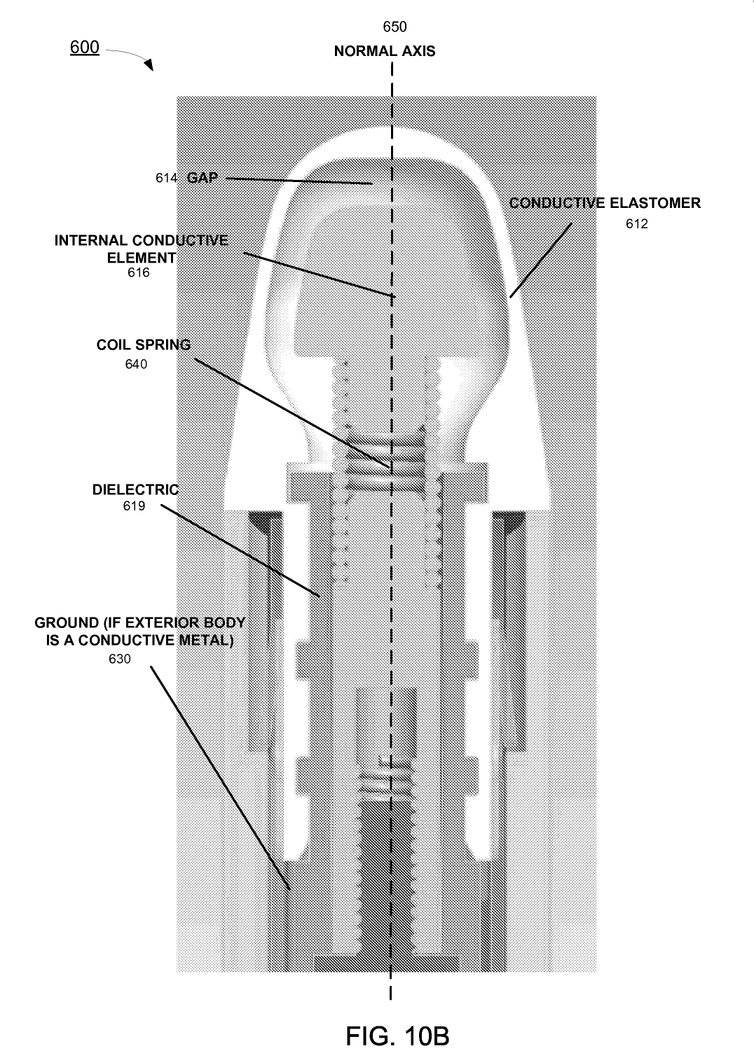

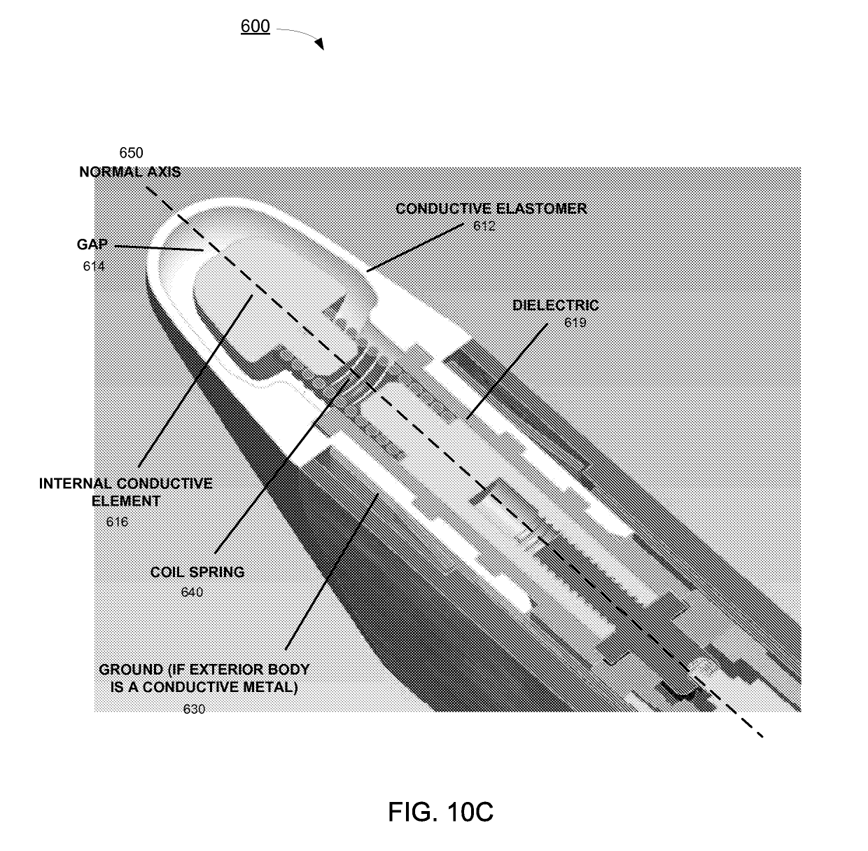

FIGS. 10A-C are cross-sectional views of the tip end portion of the stylus device 600 shown in FIGS. 7-9. The cross-sectional view of tip end portion of the stylus device presented in FIG. 10A is along a plane that is orthogonal (90°) to the plane of the cross-section view presented in FIG. 10B. FIGS. 10A-C show in detail the interior geometry of the tip end portion of the stylus device that includes the coil spring. Typically, during use, the stylus device is held by users at angles that are offset from the normal axis 650. Hence, at such angles, the nature and geometry of the spring 640 allows the internal conductive element 616 to deflect (or deform) across a wide range of contact angles between the tip end portion of the stylus device and the surface of the host device. As described above, this can contribute to a relatively low actuation force used to activate the tip end portion of the stylus device across the desired angular range on the host device surface (e.g., to register a touch event). Thus the “responsiveness” of the tip end portion of the stylus device to pressure can be relatively high.

While a specific embodiment of the stylus device with the spring 640 has been described in FIGS. 7-10C above, it should be understood that it has been presented by way of example only, and not limitation. In other embodiments, for example, the internal conductive element 616 can include a flexible shaft, for example, a relatively thin shaft, a shaft constructed of a flexible material (e.g., an alloy, a polymer, a plastic, etc.) instead of the spring 640. In such embodiments, the flexible shaft can facilitate the side-to-side movement of the internal conductive element 616.

Note that the internal conductive element 616 can be configured to bend a sufficient amount to allow for ease of use for the user over a range of angles while reducing wear on the external conductive member 612. Similarly, the internal conduct element 616 can be configured to not bend or bend a small amount such that the user does not experience noticeable or performance-preventing compression of the device during use. The location of the spring 640 or other suitable bendable element can be abutting to, adjacent to, or axially displaced from the external conductive member 612 such that the internal conduct element 612 bends a sufficient amount to allow for ease of use for the user over a range of angles while reducing wear on the conductive elastomer tip.

In known drawing applications on electronic host devices (e.g., handheld electronic tablets), the user typically accesses the brush or stylus device setting in a user interface (UI) menu on the device screen or presses a button on the stylus device to modify the stylus device's functionality. In the embodiment of the stylus devices described herein, the ‘switch’ function at both end portions of the stylus devices can enable communication of unique signals representing which end portion is touching down on the surface of the host device. This is particularly useful when an application allows for multiple-functions by the stylus device such as using the tip end portion to draw and the eraser end portion to erase without having to pick through menus or settings. This allows for an increased seamless and natural user experience for the user. The embodiments of the stylus device described herein can enable multi-function use of a stylus device without the use of UI menus and/or buttons on stylus devices by providing a two sided tool the user can naturally flip over for added functionality.

While a specific embodiment of a dual tipped stylus device (write/draw and erase) has been described above, it should be understood that it has been presented by way of example only, and not limitation. In other embodiments, each end portion of the stylus device can implement multiple functionalities such as, for example, the eraser end portion of the stylus device can implement a “soft” erase function and a “hard” erase function (e.g., based on the angle or pressure at which the eraser end is applied to the host device), and the write/draw tip end portion of the stylus device can have an option to choose different colors for writing and/or drawing. In another example, the eraser end portion of the stylus device can implement an erase function and/or a blend function (for different colors), and the write/draw tip end portion of the stylus device can implement an ink tool (that can allow for smearing while drawing) and/or a pencil tool. In such embodiments that include multiple functionalities at each end portion of the stylus device, a separate activation mechanism can exist for each functionality, so that a user can select one functionality from two or more possible choices for a given end portion of the stylus device. In such embodiments, the memory can store instructions that can allow the processor to choose the different functionalities in each end portion.

For example, in some configurations where each end portion of the stylus device can implement multiple functionalities, the user can select (e.g., using the stylus device or a finger) a desired functionality from an appropriate UI menu on the host device screen. Alternatively, a user can, for example, push a selection button on the stylus device to select a desired functionality and an indicator (not shown) on the stylus device can indicate which functionality has been selected (e.g., an indicator light(s) that changes color, changes brightness, starts blinking, etc.; numerical indicator). In yet another alternative, a user can tap the specific location of the UI menu with the end portion of the stylus device while an indicator on the stylus device changes configuration (e.g., changes color, changes brightness, starts blinking, etc.) or while an indicator of the UI menu changes configuration and can indicate which functionality has been selected. Thus, the desired functionality for a given end portion of the stylus device can selected and the host device can communicate with the stylus device for the successful implementation of the desired functionality on each end portion of the stylus device.

In some embodiments, the force, pressure, and/or deflection applied to an internal conductive element or external conductive member can be measured, for example, via a pressure gauge, strain gauge, or any other suitable means. A processor can detect the applied force, pressure, and/or deflection, and be operable to transmit an associated signal to a host device. The host device can modify or modulate an input based on such a signal. For example, if a user presses relatively hard while moving a stylus across a screen of the host device, a relatively thick line can be applied to a GUI; if the user presses relatively softly, a relatively thin line can be applied.

Where methods described above indicate certain events occurring in certain order, the ordering of certain events may be modified. Additionally, certain of the events may be performed concurrently in a parallel process when possible, as well as performed sequentially as described above.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. An apparatus, comprising:
a first tip member configured to be detected by a host device;
a second tip member configured to be detected by the host device;
a body, the first tip member coupled to a distal end portion of the body, the second tip member coupled to a distal end portion of the body;
a first conductive element coupled to the distal end portion of the body, the first conductive element and the first tip member defining, at least in part, a gap electrically isolating the first conductive element from the first tip member when the first tip member is in an unbiased configuration, the first tip member electrically coupled to the first conductive element when the first tip member is in a biased configuration;
a second conductive element coupled to the proximal end portion of the body, the second conductive element configured to be selectively electrically coupled to the second tip member; and
a communications module implemented in at least one of a processor or a memory, the communication module coupled to the body and configured to send a first signal to the host device when the first tip member is electrically coupled to the first conductive element, the communications module configured to send a second signal to the host device when the second conductive element is electrically coupled to the second tip member.

2. The apparatus of claim 1, wherein the entire gap is disposed distal to the body.

3. The apparatus of claim 1, wherein the first conductive element is coupled to the body via a spring.

4. The apparatus of claim 1, wherein the first conductive element is mechanically coupled to the body via a spring having a first spring constant in an axial direction and second spring constant in a radial direction, the second spring constant being less than the first spring constant.

5. The apparatus of claim 1, wherein the first conductive element is mechanically coupled to the body via a flexible member such that the first conductive element is configured to move relative to the body when a force is applied to the first conductive element via the first tip member.

6. The apparatus of claim 1, wherein the first conductive element is mechanically coupled to the body via a flexible member such that as a force applied to the first tip member increases, the first internal conductive element moves relative to the housing and a size of a contact patch between the first conductive element and the first tip member increases.

7. The apparatus of claim 1, further comprising a flexible member coupling the first conductive element to the body, the flexible member including a strain gauge.

8. The apparatus of claim 1, wherein:
when the first conductive tip member is in an unbiased configuration, the gap has a first length between the distal most point of the first tip member and the first conductive member and a second length between a side of the first tip member and the first conductive member, the first length being greater than the second length.

9. The apparatus of claim 1, wherein:
when the first tip member is in an unbiased configuration the gap has a first length between the distal most point of the first tip member and the first conductive member and a second length between a side of the first tip member and the first conductive member such that a minimum of a first force is used to electrically couple the distal most point of first tip member to the first conductive element and a minimum of a second force is used to electrically couple the side of the first tip member to the first conductive member, the first force being greater than the second force.

10. The apparatus of claim 1, wherein:
the gap is a first gap,
the second conductive element and the second tip member defining, at least in part, a second gap electrically isolating the second conductive element from the second tip member when the second tip member is in an unbiased configuration,
the second tip member electrically coupled to the second conductive element when the second tip member is in a biased configuration.

11. The apparatus of claim 10, wherein the entire second gap is disposed proximal to the housing.

12. An apparatus, comprising:
an electronic circuit system configured to detect when a first end of a stylus is in contact with a surface, the electronic circuit system configured to detect when a second end of the stylus is in contact with a surface, the electronic circuit system including:
a first circuit associated with the first end of the stylus that includes a first conductive element and a first tip member, the first conductive element and the first tip member collectively defining a first switch biased in an open configuration, the first switch configured to move from its open configuration to a closed configuration when the first tip member deforms in response to contacting the surface; and
a second circuit associated with the second end of the stylus that includes a second conductive element and a second tip member, the second conductive element and the second tip member collectively defining a second switch biased in an open configuration, the second switch configured to move from its open configuration to a closed configuration when the second tip member deforms in response to contacting the surface; and
a communications module implemented in at least one of a processor or a memory, the communications module operatively coupled to the electronic circuit system and configured to send a first signal to a host device when the first switch is closed and to send a second signal to the host device when the second switch is closed.

13. The apparatus of claim 12, further comprising:
a voltage source operatively coupled to the electronic circuit system, the voltage source configured to supply an electrical potential to the first conductive element,
the electronic circuit system configured to detect that the first end of the stylus is in contact with the surface when the first switch is in the closed configuration and the first circuit is completed.

14. The apparatus of claim 12, further comprising:
a voltage source operatively coupled to the electronic circuit system, the voltage source configured to supply an electrical potential to the first conductive element and to the second conductive element,
the electronic circuit system configured to detect that the first end of the stylus is in contact with the surface when the first switch is in the closed configuration and the first circuit is completed,
the electronic circuit system configured to detect that the second end of the stylus is in contact with the surface when the second switch is in the closed configuration and the second circuit is completed.

15. The apparatus of claim 12, further comprising:
a body disposed between the first tip member and the second tip member, the first entire switch disposed distal of the body.

16. The apparatus of claim 12, further comprising:
a body disposed between the first tip member and the second tip member, the entire first switch disposed distal of the body, the entire second switch disposed proximal of the body.

17. The apparatus of claim 12, further comprising:
a body disposed between the first tip member and the second tip member, the entire first switch disposed distal of the body, the entire second switch disposed proximal of the body, at least a portion of the first circuit disposed within the body.

18. The apparatus of claim 12, wherein the first switch is in the open configuration when a gap defined, at least in part, by the first tip member and the first conductive member electrically isolates the first tip member from the first conductive member.

19. The apparatus of claim 12, wherein:
the first switch is in the open configuration when a gap defined, at least in part, by the first tip member and the first conductive member electrically isolates the first tip member from the first conductive member,
the first switch is in the closed configuration when a force applied to the tip member causes the tip member to deform such that the gap is closed and the first tip member is electrically coupled to the first conductive member.

20. A method, comprising:
detecting, at an electronic circuit system and at a first time, a first switch associated with a first end of a dual-tipped stylus moving from an open configuration to a closed configuration, the first switch configured to move from the open configuration to its closed configuration when a first tip member deforms at least a threshold amount in response to contacting a surface to contact a conductive element;
sending a first signal to a host device in response to detecting the first switch moving to its closed configuration;
detecting, at a second time, a second switch associated with a second end of the dual-tipped stylus moving from an open configuration to a closed configuration; and
sending a second signal to the host device in response to detecting the second switch moving to its closed configuration.

21. The method of claim 20, further comprising:
pairing the dual-tipped stylus with the host device before sending the first signal and before sending the second signal.

22. The method of claim 20, wherein the first signal is sent wirelessly from the dual-tipped stylus to the host device.

23. The method of claim 20, further comprising:
detecting, at a third time between the first time and the second time, the first switch moving from its closed configuration to its open configuration.

24. The method of claim 20, wherein:
detecting the second switch moving from its open configuration to its closed configuration further includes detecting that the first switch is in its open configuration such that the second signal is sent only if the first switch is in its open configuration.
